(19) United States
(12) Patent Application Publication
(10) Pub. No.: US 2015/0134818 A1
(43) Pub. Date: May 14, 2015

(54) DATA SHARING METHOD AND DATA SHARING GATEWAY CONFIGURATION

(71) Applicant: CubeITz Ltd, Dorset (GB)

(72) Inventors: Sean Patrick KEARNEY, Dorset (GB); Dave DUKE, Corby (GB)

(73) Assignee: CubeITz Ltd, Dorset (GB)

(21) Appl. No.: 14/079,248

(22) Filed: Nov. 13, 2013

(51) Int. Cl. H04L 29/06

(52) U.S. Cl. CPC H04L 65/1063
USPC 709/225

(57) ABSTRACT

It is disclosed herein a computer implemented method for sharing one or more application items in a data sharing gateway. The method includes storing one or more application items in the gateway in which each application item is independent of a user or user account and registering one or more users with the data sharing gateway such that each user can dynamically use each application item stored in the gateway.

### FIELD OF INVENTION

The present invention relates to a data sharing method and a data sharing gateway configuration.

### BACKGROUND OF THE INVENTION

It is now common for an individual to regularly use multiple computers from multiple different locations. A typical user may have a first computer at the office and a second computer at home, for example, as well as a portable computer, and a web-enabled mobile device such as a smartphone. To have ready access to the user's content, it is desirable for the user to share his files between these multiple computers.

Another attempt to solve this problem has involved the use of network storage devices, whereby services offer users the opportunity to store their documents “in the cloud”—that is, on servers accessible to users via the Internet or other network. In the above example, a user who is interested in working on a document from multiple locations can store the document on a network file server and then edit it from home, work, or any other location that provides network access to the file server.

It is also common that the individual needs to share files between different users. An attempt to share files between various users have been addressed in US20120331108. In this document, a first user stores a file in a server and then sends an online link to specific other users to whom the first user wishes to share the files. The other users need to be authorized to use the online link and subsequently access the files the first user wishes to share with the other users. In this case, the files are always associated with certain number of users who can only use them. The online link is also always associated with certain number of application files. In order to send the online link, the first user always needs to register with a file sharing server and then using the registration information s/he can send the file sharing link to other desired users. It is apparent that generating online links each time files need to be shared is not efficient. It also requires user registration process, and using user name and password numerous times.

Furthermore, it has been also known from EP1517206 that file sharing portal exists in which a portal user has only a role based access to applications specific to such roles only. For example, a series of technicians can access applications which are only related to technician applications. Therefore the portal is configured to certain number of role based users and the portal contains corresponding role based applications only. Furthermore, the portal is used to connect to remote systems/services so that certain role based users (e.g. a technician) can access such remote systems/services.

It is an object of the present invention to address the problems stated above.

### SUMMARY OF THE INVENTION

According to one aspect of the present invention there is provided a computer implemented method for sharing one or more application products in a data sharing portal or gateway, the method comprising: storing the one or more application products in the portal or gateway, wherein each application product is independent of a user or user account; and registering one or more users with the data sharing portal or gateway such that each user can dynamically use each application product stored in the portal or gateway.

It will be appreciated that the term “gateway” refers to an application platform in which various application items can be shared between users. The application platform can be created by a user and after the creation of the gateway other users who are registered with the gateway can share application items in the gateway. Once the gateway is created, all the application items associated with the gateway are available to the registered user and therefore none of the users is specifically linked with a particular application item. Each user can dynamically use each application item stored in the gateway.

The present invention helps to ensure that any application item stored in the gateway or portal inherits the settings and permission level of the gateway or portal and therefore the application item being stored is not associated with a user account or user information. Therefore the users only need to log into the portal once to use the applications in the portal. The users can dynamically use more than one application items together just by logging into the system once. This is advantageous over the conventional data sharing techniques in which certain number of application items are always associated with a particular user who then needs to generate an online link for sending over to other users with whom the application items can be shared. In the conventional techniques, the stored application items are always linked with a particular user. This is not present in the present invention in which as soon as the application items are stored they are disassociated with the user information so that any number of registered users with the gateway can use them according to their permission level.

The step of storing one or more application products may comprise disassociating the one or more application products from any user or user account information. The disassociation may be conducted such that none of the one or more application products is owned by a particular user or user account when the one or more application products are stored in the data sharing portal.

The step of storing one or more application products may comprise storing at least two independent application products. It will be appreciated that the term “dynamic use” refers that one particular user can use two or more application products at the same time. Similarly one application product can be dynamically used by two or more users at the same time.

The step of registering may comprise registering one or more users only once with the portal or gateway which provides each user access to each stored application product. The step also requires that the user only logins once to the portal or gateway to use the stored application items. This is advantageous over the conventional technique in which multiple registrations and multiple logins to the system is required.

The step of registering may comprise employing an access profile associated with each user which enables each user to control each application product in the portal. The access profile may be associated with one or more attributes comprising a read, a write and/or a locking attribute. The locking attribute refers to the situation when a particular user can neither modify nor delete for a defined period. The attributes associated with each user's access profile may be applicable to each application product stored in the portal. The attributes are generally permission levels allocated to each user. Depending upon these permission levels each user can access each application in the portal.

According to a further aspect of the present invention, there is provided a computer-readable storage medium having executable computer program instructions embodied therein that when executed by a data sharing portal or gateway perform actions comprising: storing one or more application products in the portal or gateway, wherein each application product is independent of a user or user account; and registering one or more users with the data sharing portal or gateway such that each user can use each application product stored in the portal or gateway.

It will be appreciated that the storage medium may have processor control code to perform the actions stated above. The application items are generally stored in an application server which may be a part of the data sharing portal or gateway configuration. Alternatively the application server can be a remote device configured to be connected to the data sharing portal or gateway configuration.

The action of storing one or more application products may include disassociating the one or more application items from any user or user account information.

The disassociation may be conducted such that none of the one or more application items is owned by a particular user or user account when the one or more application items are stored in the data sharing portal.

The action of storing one or more application products may include storing at least two independent application items.

The action of registering may include registering the one or more users only once with the portal or gateway which provides each user access to each stored application item.

The action of registering may comprise employing an access profile associated with each user which enables each user to control each application item in the portal.

The access profile may be associated with one or more attributes comprising a read, a write and/or a locking attribute. The attributes associated with each user's access profile may be applicable to each application product stored in the portal.

According to a further aspect of the present invention, there is provided a data sharing gateway configuration comprising: a computer processor; and a computer readable medium storing a computer program executable by the computer processor to: store one or more application products in the portal or gateway, wherein each application product is independent of a user or user account; and register one or more users with the data sharing gateway such that each user can use each application product stored in the gateway.

The computer program may further comprise program to store the one or more application products in which the program is adapted to disassociate the one or more application products from any user or user account information.

The disassociation may be conducted such that none of the one or more application products is owned by a particular user or user account when the one or more application products are stored in the data sharing portal or gateway.

The computer program may further comprise program to register the one or more users only once with the portal or gateway configuration which provides each user access to each stored application product.

### BRIEF DESCRIPTION OF PREFERRED EMBODIMENTS

These and other aspects of the invention will now be further described, by way of example only, with reference to the accompanying figures in which:

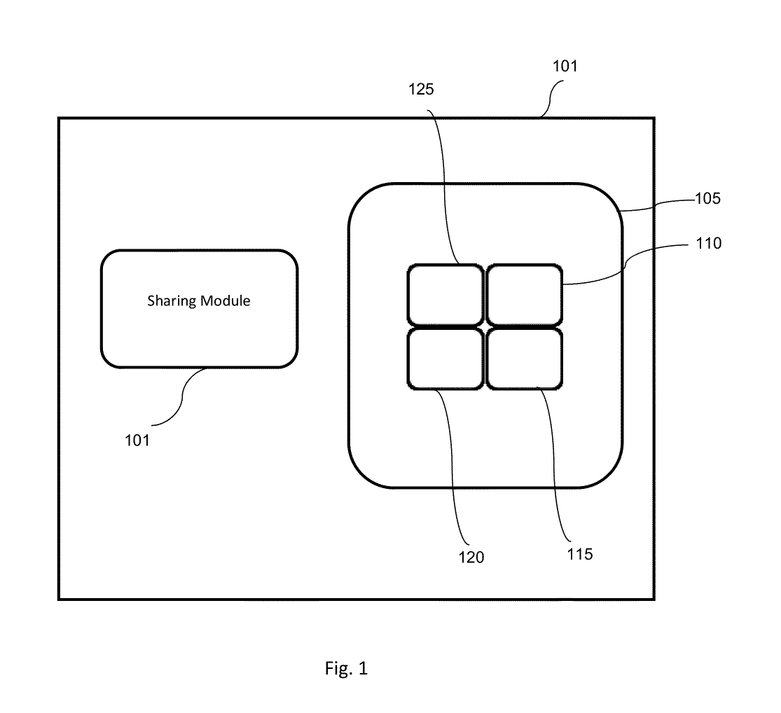

FIG. 1 illustrates a schematic diagram of a data sharing gateway configuration 101;

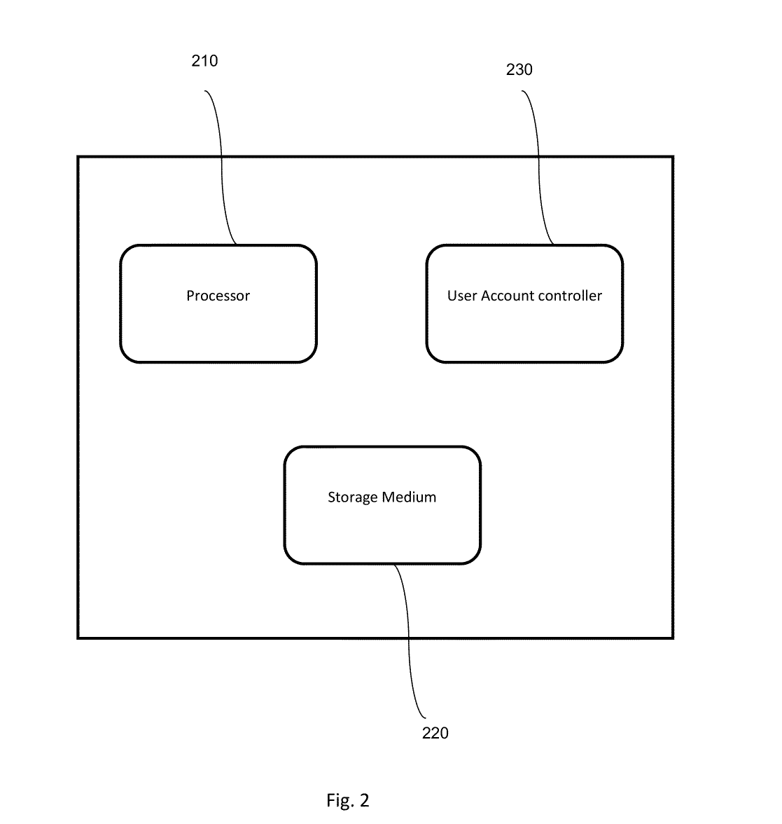

FIG. 2 illustrates a schematic diagram of the sharing module 130 of FIG. 1; and

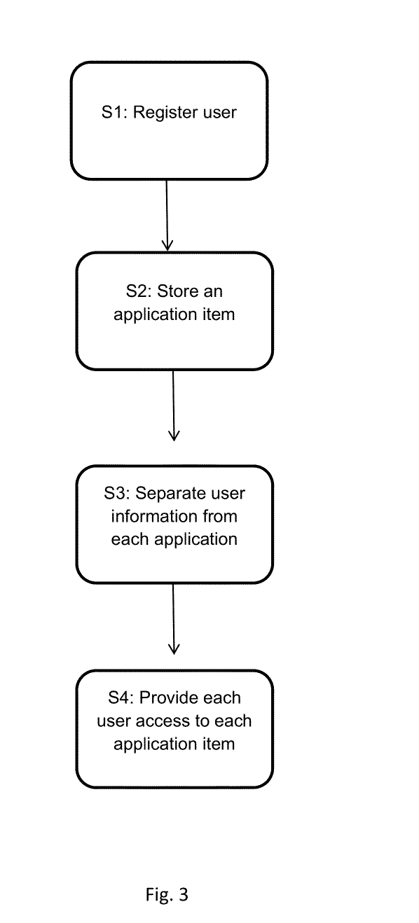

FIG. 3 is a flow diagram illustrating steps involved for sharing one or more application items between different users.

### DETAILED DESCRIPTION OF PREFERRED EMBODIMENTS

FIG. 1 illustrates a schematic diagram of a data sharing gateway configuration 101. The gateway configuration 101 includes an application server 105 in which, for example, four applications 110, 115, 120 and 125 are stored. The gateway configuration 101 also includes a sharing module 130 which controls each application stored in the application server 105. As mentioned before, in alternative examples, the application server 105 can be a remote device to which the sharing module 130 may be configured to be remotely connected.

FIG. 2 illustrates a schematic diagram of the sharing module 130 of FIG. 1. The sharing module 130 includes a processor 210, a storage medium 220 and a user account controller 230. The storage medium 220 generally contains computer program code which is generally executed by the processor 210 to control the data sharing gateway 101. User account information is also stored in the storage medium 220 and the user account controller 230 controls allocating various attributes such as read, write and/or locking to each user. It will be appreciated that the above configurations of the sharing module 130 and the data sharing gateway 101 are not limiting. The skilled person may be able to contemplate various other configurations to achieve the main goal of the invention.

In preferred embodiments, any number of users can share any number of applications among the users. For example, a user can register with the data sharing gateway 101 and the user account controller 230 of the sharing module 130 provides necessary permission attributes to the user so that s/he can access each application according to the allocated permission attribute. The user can have both read and write authorities or can have either of these. Another permission level namely locking can be provided. The locking attribute prohibits the allocated user to modify or delete the allocated data for a certain period.

In one embodiment, when a user would like to share an application item with other users, s/he needs to first register with the sharing gateway 101. After the registration, the user can store the application item into the application server 105 of the gateway 101. All the users registered to the gateway 101 thus have access to the application item just stored in the application server 105. Depending upon the attribute permission level, the user who has just registered has access to all the application items stored in the gateway 101. These applications stored in the gateway are not related to one another. The gateway 101 may be configured such that each user can use each application in the gateway. The user interface for each user generally needs to be programmed in such a way that different disassociated applications can be used by the same user from the gateway 101. It is thus apparent that each user needs to register only once with the gateway 101 to share application items among different users. It may be more efficient and convenient compared with the conventional portals or gateways in which users may need to use username and password for each sharing activity or users need to generate specific links allowing to share only specific role based applications.

The application items stored in the application server 105 can generally be stored by registered user or can be provided at the time the gateway 101 is initially created. As soon as the application items are stored in the application server 105, the application items are not linked or associated with any particular user. The gateway is configured to separate user account information from the application item after the application item being stored in the portal. It will be appreciated that a particular user is the owner of the gateway who initially creates the gateway to share application items with other registered users. The owner can have the management ability to control the created gateway such that each application item is not associated with any user after the application item has been stored. When the application items are stored, they inherit the accessibility permission level already allocated to the users of the gateway 101. Any number of users registered with the gateway can then access the application items. In this way, the user needs to only register once with the gateway 101 and s/he does not need to generate any link or does not need to use username or password each time the user wants to share an application item. Each user can access dynamically two or more application items. It may be possible for a particular user to use two or more disassociated or discrete application items at the same time. Similarly it may be possible that two or more users can use the same application item at the same time. There may not be any limitation on each user that s/he can only use specific ‘role based’ applications. For example, a technician does not have to use only application items related to automotive uses. The technician can freely use application items, for example, related to accountancy applications as well.

In preferred embodiments, the application server 105 of FIG. 1 stores four applications. In one embodiment, the first application 125 is a car mechanic calendar, the second application 120 is a customer calendar, the third application 115 is an accounts and transaction system and the fourth application 110 is a voting system. For this example, the sharing gateway 101 has two users registered. The first user is the car mechanic and the second user is a customer of the car mechanic. Both the users are given permissions that they can read and write on all of the four stored applications. Therefore the customer can see the mechanic's calendar and then book an appointment with the mechanic on an available slot. The mechanic can accept the appointment using the first application 124 and then confirm the appointment at the second application 120 related to the customer. After the repairing work, the car mechanic can bill the customer using the third transaction system application 115 and the customer can pay the bill using the same third application 115. Depending upon the level of service the customer has received, s/he can rate/vote for the mechanic using the voting application 110 and the mechanic can also rate the customer using the same application 110.

It would be appreciated that, for the example above, the car mechanic may be the creator or owner of the gateway and therefore he can have the management ability to see the activity of all the application items and if necessary create a summary report for each application items being used. It would also be apparent that each user can use all the applications stored in the gateway by registering only once and the use of each application item is not restricted to a specific role. In this example, the data sharing gateway 101 is owned by the car mechanic and it would be possible to transfer over the data sharing gateway 101 to a new owner if the car mechanic wishes to sell his business. This would be advantageous because the new owner only needs to run the data sharing gateway 101 to carry on further with the business rather than setting up a new data sharing gateway and the associated application/software platform for the same purpose. It is therefore apparent that the data sharing gateway 101 of the present invention is transferrable on its entirety to a new owner/customer without modifying any technical configuration of the gateway.

FIG. 3 is a flow diagram illustrating exemplary steps involved for sharing one or more application items between different users.

In step 1, a user registers with the data sharing gateway configuration 101. It would be appreciated that many users can be registered with the gateway configuration 101. After the registration, the details of the users can be found in a contact list. A particular registered user can start sharing any application items with other registered users. The particular registered user then creates or generates a gateway and includes other registered user from the contact list. At this stage, the other users are given a permission level whether s/he could read, write and/or lock (to delete or modify an application item).

In step 2, the user can store an application item into the application server 105 of the created gateway 101.

In step 3, the gateway is configured to separate the user account information from the application item so that none of the application items stored in the gateway are linked with any particular user.

In step 4, the gateway provides each user access to each application item. Each user can use/control at least two application items together and each application can be used by two users at the same time. This does not require each user to register and/or login to the gateway every time file sharing is necessary.

Thus the present invention provides the advantage that any type of application items can be shared through the gateway between any numbers of users. The application items do not have to be for any particular purpose. Each user can use two or more independent or disassociated application items at the same time (dynamically). Any application items can be put in the data sharing portal which is configured to make the application items available to all the registered users. This provides an overall flexibility over the existence data sharing techniques data sharing platforms in which application items are role based or the users are specific to particular roles. The existing sharing techniques are not compatible with any types of software or application items. The existing techniques are configured for particular application or software types only. The conventional data sharing techniques do not provide dynamic access of two or more application items which are completely disassociated with each other.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A computer implemented method for sharing one or more application items in a data sharing gateway, the method comprising:
storing said one or more application items in the gateway, wherein each application item is independent of a user or user account;
registering one or more users with the data sharing gateway such that each user can dynamically use each application item stored in the gateway.

2. A method according to claim 1, wherein the step of storing one or more application items comprises disassociating said one or more application items from any user or user account information.

3. A method according to claim 2, wherein the disassociation is conducted such that none of said one or more application items is owned by a particular user or user account when said one or more application items are stored in the data sharing gateway.

4. A method according to claim 1, wherein the step of storing one or more application items comprises storing at least two independent application items.

5. A method according to claim 1, wherein the step of registering comprises registering said one or more users only once with the gateway which provides each user access to each stored application item.

6. A method according to claim 1, wherein the step of registering comprises employing an access profile associated with each user which enables each user to control each application item in the gateway.

7. A method according to claim 6, wherein the access profile is associated with one or more attributes comprising a read, a write and/or a locking attribute.

8. A method according to claim 7, wherein said attributes associated with each user's access profile are applicable to each application item stored in the gateway.

9. A computer-readable storage medium having executable computer program instructions embodied therein that when executed by a data sharing gateway perform actions comprising:
storing one or more application items in the gateway, wherein each application item is independent of a user or user account;
registering one or more users with the data sharing gateway such that each user can use each application item stored in the gateway.

10. A computer-readable storage medium according to claim 9, wherein the action of storing one or more application items comprises disassociating said one or more application items from any user or user account information.

11. A computer-readable storage medium according to claim 10, wherein the disassociation is conducted such that none of said one or more application items is owned by a particular user or user account when said one or more application items are stored in the data sharing gateway.

12. A computer-readable storage medium according to claim 9, wherein the action of storing one or more application items comprises storing at least two independent application items.

13. A computer-readable storage medium according to claim 9, wherein the action of registering comprises registering said one or more users only once with the gateway which provides each user access to each stored application item.

14. A computer-readable storage medium according to claim 9, wherein the action of registering comprises employing an access profile associated with each user which enables each user to control each application item in the gateway.

15. A computer-readable storage medium according to claim 14, wherein the access profile is associated with one or more attributes comprising a read, a write and/or a locking attribute.

16. A computer-readable storage medium according to claim 15, wherein said attributes associated with each user's access profile are applicable to each application item stored in the gateway.

17. A data sharing gateway configuration comprising:
a computer processor; and
a computer readable medium storing a computer program executable by the computer processor to:
store one or more application items in the gateway, wherein each application item is independent of a user or user account;
register one or more users with the data sharing gateway such that each user can use each application item stored in the gateway.

18. A data sharing gateway configuration according to claim 17, wherein the computer program further comprises program to store said one or more application items in which said program is adapted to disassociate said one or more application items from any user or user account information.

19. A data sharing gateway configuration according to claim 18, wherein the disassociation is conducted such that none of said one or more application items is owned by a particular user or user account when said one or more application items are stored in the data sharing gateway.

20. A data sharing gateway configuration according to claim 17, wherein the computer program further comprises program to register said one or more users only once with the gateway configuration which provides each user access to each stored application item.
